(19) United States
(12) Patent Application Publication
(10) Pub. No.: US 2014/0365308 A1
(43) Pub. Date: Dec. 11, 2014

(54) INFORMATION PROVISION SYSTEM, WIRELESS TERMINAL, AND INFORMATION PROVISION METHOD

(71) Applicant: Yahoo Japan Corporation, Tokyo (JP)

(72) Inventor: Takayuki TSUCHIYA, Tokyo (JP)

(73) Assignee: Yahoo Japan Corporation, Tokyo (JP)

(21) Appl. No.: 14/013,386

(22) Filed: Aug. 29, 2013

(30) Foreign Application Priority Data
Jun. 11, 2013 (JP) 2013-123164

(51) Int. Cl. G06Q 30/02; H04W 48/16

(52) U.S. Cl. CPC G06Q 30/0267; H04W 48/16
USPC 705/14.64; 370/338

(57) ABSTRACT

A wireless terminal according to an embodiment includes a list of identification information of wireless LAN access points according to a behavior history of a user, and receives information corresponding to an entrance place from an information management device when the entrance to a communication area of a wireless LAN access point whose identification information is included in the list is performed.

### CROSS-REFERENCE TO RELATED APPLICATIONS

The present application claims priority to and incorporates by reference the entire contents of Japanese Patent Application No. 2013-123164 filed in Japan on Jun. 11, 2013.

### BACKGROUND OF THE INVENTION

1. Field of the Invention

The present invention relates to an information provision system, a wireless terminal, and an information provision method.

2. Description of the Related Art

In recent years, public wireless Local Area Network (LAN) communication has rapidly become popular. In places such as stations, airports, and stores, wireless LAN access points are installed, and various mobile devices such as person computers, mobile telephones, and portable game machines are equipped with a wireless LAN communication function as a basic function.

Such public wireless LAN communication is expected to become more popular, and users of mobile devices which are wireless terminals are expected to be able to use an access environment to the high-speed Internet in more various places.

In this regard, the present applicant has proposed an information provision system that includes a wireless LAN access point and an information management device and is capable of appropriately notifying a user of a wireless terminal of information (see Japanese Patent No. 5175401).

In the technique disclosed in Japanese Patent No. 5175401, information notification can appropriately be given to the user of the wireless terminal, but a function of detecting a wireless terminal present within a wireless LAN communication area and transmitting detection information to the information management device has to be added to the wireless LAN access point.

### SUMMARY OF THE INVENTION

According to the exemplary embodiment, an information provision system includes a wireless terminal with a wireless LAN communication function, a plurality of wireless LAN access points, and an information management device. The wireless terminal includes a list generating unit, an entrance detecting unit, an information transmitting unit, and an information receiving unit. The list generating unit generates a list of identification information of the wireless LAN access points according to a behavior history of a user of the wireless terminal. The entrance detecting unit detects an entrance to a communication area of the wireless LAN access point having identification information included in the list. The information transmitting unit transmits the identification information of the wireless LAN access point having an entered communication area to the information management device when the entrance detecting unit detects the entrance to the communication area. The information receiving unit receives information transmitted from the information management device in response to transmission of the identification information by the information transmitting unit. The information management device includes an information providing unit. The information providing unit receives the identification information transmitted from the wireless terminal and transmits information corresponding to the received identification information to the wireless terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are explanatory diagrams of an information provision process according to an embodiment;

FIG. 2 is a diagram illustrating an exemplary configuration of an information provision system according to an embodiment;

FIG. 3 is a diagram illustrating an exemplary configuration of a wireless LAN access point illustrated in FIG. 2;

FIG. 4 is a diagram illustrating an exemplary configuration of a wireless terminal illustrated in FIG. 2;

FIG. 5 is a diagram illustrating an AP-ID list of a wireless terminal;

FIG. 6 is a diagram illustrating exemplary setting information of a wireless terminal;

FIG. 7 is a diagram illustrating an exemplary stay state determination table of a wireless terminal;

FIG. 8 is a diagram illustrating exemplary behavior history information of a wireless terminal;

FIGS. 9A to 9D are diagrams illustrating an exemplary screen displayed on a display unit of a wireless terminal;

FIG. 10 is a diagram illustrating an exemplary configuration of an information management device illustrated in FIG. 2;

FIG. 11 is a diagram illustrating an exemplary advertising information table of an information management device;

FIG. 12 is a diagram illustrating an exemplary place information table of an information management device;

FIG. 13 is a flowchart illustrating exemplary information processing of a wireless terminal according to an embodiment; and

FIG. 14 is a flowchart illustrating exemplary information processing of an information management device according to an embodiment.

### DETAILED DESCRIPTION OF THE PREFERRED EMBODIMENTS

Hereinafter, an exemplary embodiment of an information provision system, a wireless terminal, a program, and an information provision method according to the present disclosure will be described in detail with reference to the accompanying drawings. Further, an information provision system, a wireless terminal, a program, and an information provision method according to the present disclosure are not limited to the following embodiment. Hereinafter, a database is referred to simply as a “DB.”

1. Configuration of Information Provision Process

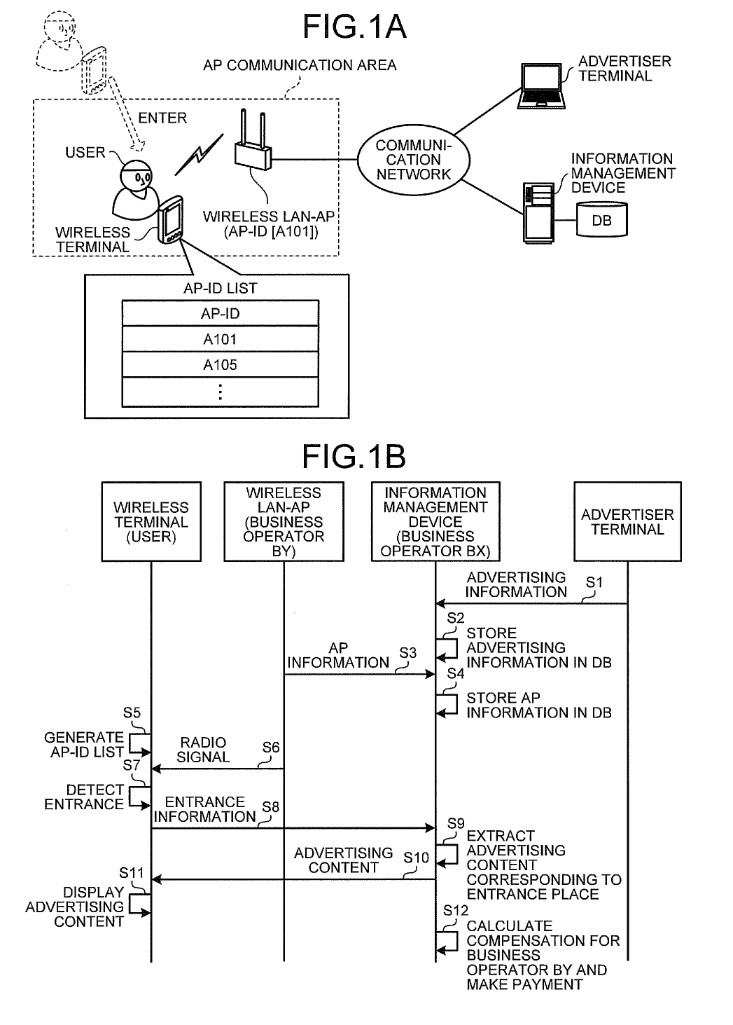

First of all, an information provision process according to an embodiment will be described. FIGS. 1A and 1B are explanatory diagrams of an information provision process according to an embodiment, and an information provision system according to the present embodiment performs the information provision process. In the following, advertising content will be described as an example of provision information in the information provision process, and the provision information is not limited to the advertising content.

The information provision system according to an embodiment includes a wireless terminal, a wireless LAN access point (wireless LAN-AP), and an information management device as illustrated in FIG. 1A. The wireless LAN access point and the information management device are connected with each other via a communication network. The wireless terminal is connected to the communication network through the wireless LAN access point, but can be connected directly to the communication network.

Although not illustrated, one or more wireless LAN access points are installed at each place such as stores or facilities of business operators. Examples of stores or facilities of business operators include retail stores, restaurants, hair salons, barber shops, hospitals, hotels, stores in complex leisure facilities, and event sites in which concerts or sports activities are held. The stores or facilities of business operators may be referred to as business places.

The information management device stores advertising information transmitted from advertiser terminals in a DB. The advertising information includes advertising content and a delivery condition. For example, the information management device is managed by an advertising distributor, and advertising content is provided to a wireless terminal of a user which satisfies the delivery condition. The advertising content is, for example, text advertising, still image advertising, moving image advertising, banner advertising, and animation advertising, and includes, for example, information of a product or a service, coupon information, and special sale information.

The information management device stores information (hereinafter, referred to as “AP information”) in which identification information (hereinafter, referred to as an “AP-ID”) of the wireless LAN access point is associated with information (hereinafter, referred to as “installation place information”) related to an installation place of the wireless LAN access point in a DB.

The wireless terminal is a terminal device with a wireless LAN communication function. The wireless terminal includes a storage unit that stores an AP-ID list according to a behavior history of a user. The AP-ID list is a list including one or more AP-IDs and generated and updated by a control unit of the wireless terminal based on the user's behavior.

Upon detecting that the wireless terminal enters a wireless LAN communication area (hereinafter, referred to as an “AP communication area”) of the wireless LAN access point whose AP-ID is included in the AP-ID list, the wireless terminal transmits entrance information to the information management device. Then, advertising content corresponding to installation information of the wireless LAN access point is transmitted from the information management device to the wireless terminal.

Here, an exemplary information provision process according to an embodiment will be described with reference to FIG. 1B. The advertiser terminal submits advertising information by transmitting advertising information to the information management device via the communication network (step S1). When the advertising information is received from the advertiser terminal, the control unit of the information management device stores the received advertising information in a DB (step S2).

The business operator BY having the wireless LAN access point transmits AP information of the wireless LAN access point from the terminal device of the business operator BY to the information management device via the communication network (step S3). The control unit of the information management device stores the AP information in a DB (step S4).

The control unit of the wireless terminal generates an AP-ID list based on the user's behavior (step S5). Here, AP-IDs such as “A101” and “A105” are assumed to be set to the AP-ID list as illustrated in FIG. 1A. Examples of an AP-ID include a Media Access Control (MAC) address or an Extended Service Set Identifier (ESS-ID) of the wireless LAN communication unit of the wireless LAN access point, and notation such as “A101” and “A102” is used to denote an AP-ID for convenience sake.

Thereafter, when the user of the wireless terminal enters the AP communication area of the wireless LAN access point, the wireless terminal detects a radio signal transmitted from the wireless LAN access point (step S6). The radio signal includes an AP-ID, and the control unit of the wireless terminal determines whether or not the AP-ID included in the radio signal is included in the AP-ID list.

When the AP-ID included in the radio signal is “A101,” the control unit of the wireless terminal detects the fact that the user has entered the AP communication area of the wireless LAN access point of the AP-ID included in the AP-ID list (step S7), and transmits entrance information including the AP-ID “A101” to the information management device via the communication network (step S8).

When the entrance information is received from the wireless terminal, the control unit of the information management device extracts advertising content corresponding to an entrance place of the wireless terminal from a DB (step S9). The DB of the information management device stores AP information in which an AP-ID is associated with the installation place information as described above, and the control unit of the information management device acquires the installation place information corresponding to the AP-ID included in the entrance information from the DB. Then, the control unit of the information management device extracts advertising content in which a delivery condition corresponding to the installation place information is designated from the DB.

The control unit of the information management device transmits the advertising content extracted from the DB to the wireless terminal via the communication network (step S10). When the advertising content is received from the information management device, the control unit of the wireless terminal causes the received advertising content to be displayed on a display unit (step S11). Further, the control unit of the information management device calculates a compensation amount for the business operator BY based on transmission history to the wireless terminal for each advertising content of the advertiser, and performs a payment process (step S12).

As described above, in the information provision process according to an embodiment, based on the AP-ID list according to the behavior history of the user of the wireless terminal, the entrance information is transmitted from the wireless terminal, and the advertising content is provided to the user of the wireless terminal. Thus, appropriate advertising content according to behavior of the user of the wireless terminal can be provided to the user of the wireless terminal.

Further, the business operator BY having the wireless LAN access point provides the AP information to the information management device of the business operator BX, and thus can get a compensation for information provision from the business operator BX. Thus, the business operator having the wireless LAN access point is motivated to actively participate in an information provision service, and the scale of the information provision service can be easily increased.

2. Configuration of Information Provision System 1

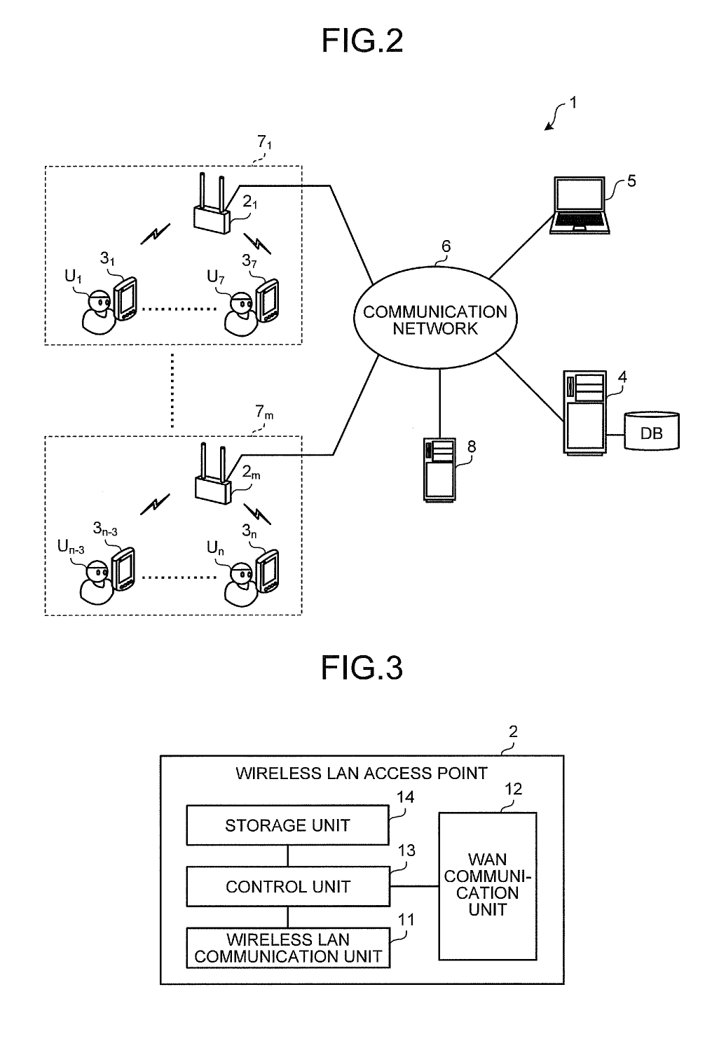

An exemplary configuration of an information provision system 1 according to an embodiment will be described with reference to FIG. 2. FIG. 2 is a diagram illustrating an exemplary configuration of the information provision system 1 according to an embodiment.

The information provision system 1 includes a plurality of wireless LAN access points 2₁ to 2ₘ (which may be hereinafter referred to collectively as a “wireless LAN access point 2”), a plurality of wireless terminals 3₁ to 3ₙ (which may be hereinafter referred to collectively as a “wireless terminal 3”), and an information management device 4 as illustrated in FIG. 2.

The wireless terminals 3₁ to 3ₙ are held by users U₁ to Uₙ (which may be hereinafter referred to collectively as a “user U”). The wireless LAN access points 2₁ to 2ₘ and the information management device 4 are connected to a communication network 6. For example, the communication network 6 is a wide area network (WAN) such as the Internet. An advertiser terminal 5, a site server 8, and the like are connected to the communication network 6.

The wireless LAN access points 2₁ to 2ₘ perform communication with the wireless terminals 3 present within AP communication areas 7₁ to 7ₘ (which may be hereinafter referred to collectively as an “AP communication area 7”) through wireless LAN communication, and relay communication with the information management device 4 or the site server 8 connected to the communication network 6 according to a request from the wireless terminal 3.

For example, the wireless LAN is a wireless LAN specified by IEEE802.11, but not limited to the wireless LAN of such a standard. The site server 8 provides information such as a web page according to a request from the wireless terminal 3.

The wireless terminal 3 is a terminal device with a wireless LAN communication function such as a mobile personal computer (PC), and is capable of performing communication with the wireless LAN access point 2. The wireless terminal 3 may be a terminal device having a wireless LAN communication function and a wireless WAN communication function such as a smart phone, and in this case, the wireless terminal 3 is capable of performing communication with the wireless LAN access point 2 and a wireless WAN base station. The wireless WAN base station is connected to the communication network 6.

An information notification application is installed in the wireless terminal 3. For example, the wireless terminal 3 can execute the information notification application by acquiring data of an information notification application program provided from the information management device 4 via the communication network 6 and developing the acquired data in an internal storage unit.

The information management device 4 receives submission of advertising information from the advertiser terminal 5, and provides advertising content included in the advertising information to the wireless terminal 3 according to an entrance place of the wireless terminal 3. Hereinafter, configurations of the wireless LAN access point 2, the wireless terminal 3, and the information management device 4 will be described in this order.

3. Configuration of Wireless LAN Access Point 2

First of all, an exemplary configuration of the wireless LAN access point 2 will be concretely described. FIG. 3 is a diagram illustrating an exemplary configuration of the wireless LAN access point 2. The wireless LAN access point 2 includes a wireless LAN communication unit 11, a WAN communication unit 12, a control unit 13, and a storage unit 14 as illustrated in FIG. 3.

The wireless LAN communication unit 11 is a communication interface that performs wireless LAN communication, and performs transmission and reception of information with the wireless terminal 3 with the wireless LAN communication function. The WAN communication unit 12 is connected to the communication network 6, and performs transmission and reception of information with a device (for example, the information management device 4 or the site server 8) connected to the communication network 6. The WAN communication unit 12 accesses the communication network 6 in a wired or wireless manner.

The control unit 13 performs an information relay process. For example, the control unit 13 is implemented by an integrated circuit (IC) such as Application Specific Integrated Circuit (ASIC) or Field Programmable Gate Array (FPGA). The control unit 13 performs the information relay process by executing a program stored in an internal storage device through an internal Central Processing Unit (CPU) or Micro Processing Unit (MPU) using a Read Only Memory (RAM) as a work area.

For example, the control unit 13 transmits information acquired from the wireless terminal 3 through the wireless LAN communication unit 11 to the information management device 4 or the site server 8 through the WAN communication unit 12, and transmits information acquired from the information management device 4 or the site server 8 through the WAN communication unit 12 to the wireless terminal 3 through the wireless LAN communication unit 11.

The wireless LAN communication unit 11 broadcasts radio packets (for example, beacons). The radio packet includes information of a MAC address or an ESS-ID of the wireless LAN communication unit 11, and the wireless terminal 3 can receive a radio packet from the wireless LAN communication unit 11 and acquire an AP-ID of the wireless LAN access point 2.

Further, when a radio packet called a probe request is broadcasted and transmitted from the wireless terminal 3, the wireless LAN communication unit 11 may transmit a radio packet called a probe response to the wireless terminal 3. The probe response includes information of a MAC address or an ESS-ID of the wireless LAN communication unit 11, and the wireless terminal 3 can receive the probe response from the wireless LAN communication unit 11 and acquire an AP-ID of the wireless LAN access point 2.

4. Wireless Terminal 3

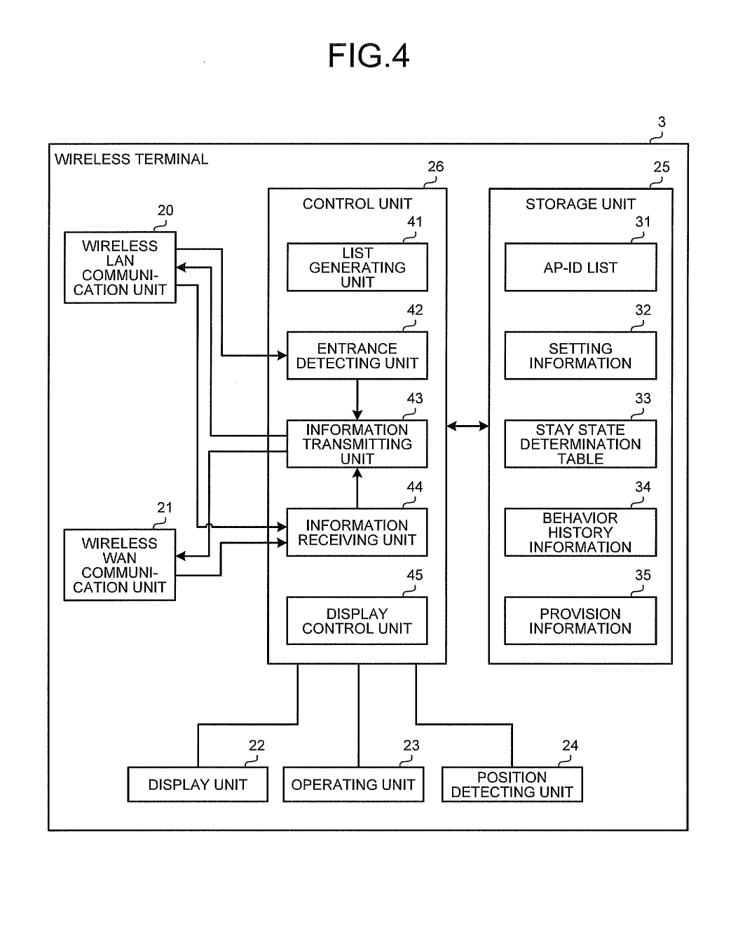

Next, a configuration of the wireless terminal 3 will be described. FIG. 4 is a diagram illustrating an exemplary configuration of the wireless terminal 3. The wireless terminal 3 includes a wireless LAN communication unit 20, a wireless WAN communication unit 21, a display unit 22, an operating unit 23, a position detecting unit 24, a storage unit 25, and a control unit 26 as illustrated in FIG. 4. The wireless LAN communication unit 20 is a communication interface that performs transmission and reception of information with the wireless LAN access point 2. The wireless WAN communication unit 21 is a communication interface that performs transmission and reception of information with a wireless WAN base station (not illustrated). For example, the wireless WAN base station is a wireless base station of a public telecommunication network or a wireless base station of a public data communication network.

The display unit 22 is a display of a touch panel type. The user U of the wireless terminal 3 can operate an operation screen of an information notification card application displayed on the display unit 22 by perform an operation on the screen of the display unit 22 using a finger or the like. For example, the display unit 22 is a small-sized Liquid Crystal Display (LCD) or an organic EL display.

The operating unit 23 includes a keyboard including keys used to input a text, a number, and a space, an enter key, an arrow key, and the like, a power button, and the like.

The position detecting unit 24 has a Global Positioning System (GPS) reception function, and acquires information of a current position of the wireless terminal 3. The information of the current position includes the latitude and the longitude but may be an address.

4.1. Storage unit 25

For example, the storage unit 25 is a semiconductor memory device such as a RAM or a flash memory or a storage device such as a hard disk or an optical disc. The storage unit 25 stores various kinds of programs. For example, the storage unit 25 stores programs such as an Operating System (OS) and the information notification card application program acquired from the information management device 4.

The storage unit 25 further stores an AP-ID list 31, setting information 32, a stay state determination table 33, behavior history information 34, and provision information 35. The information is set to the storage unit 25 and updated as the control unit 26 executes the information notification card application.

The wireless terminal 3 further includes a reading device (not illustrated), and the control unit 26 may read the information notification card application program stored in a recording medium through the reading device and store the information notification card application program in the storage unit 25. Examples of the recording medium include an optical disc, a flexible disk, and a hard disk.

4.1.1. AP-ID list 31

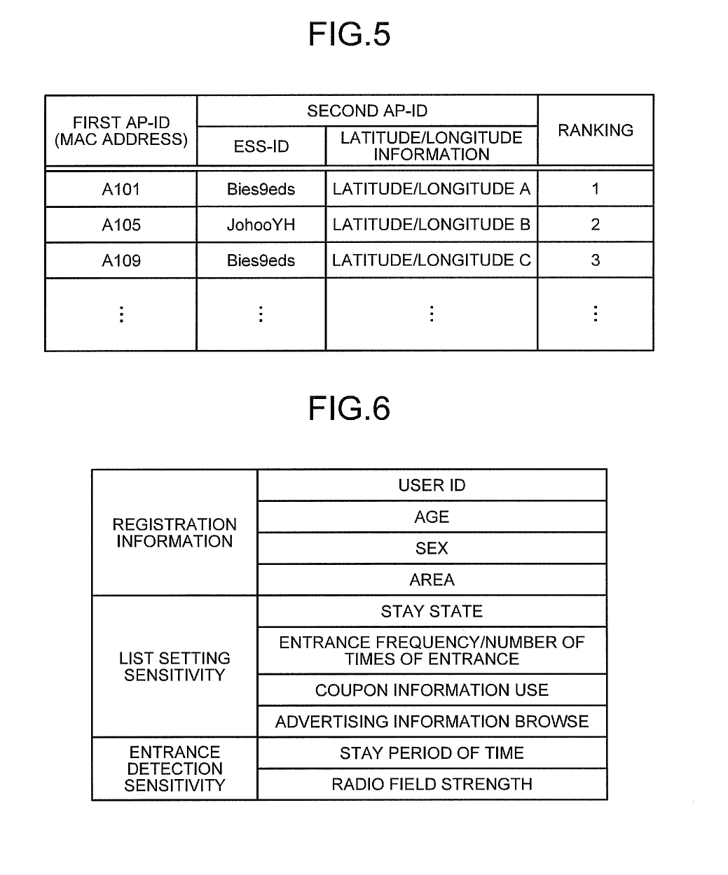

FIG. 5 is a diagram illustrating an example of the AP-ID list 31 stored in the storage unit 25. The AP-ID list 31 is information in which “first AP-ID,” “second AP-ID,” and “ranking” are associated with one another, and is generated and updated by a list generating unit 41 as illustrated in FIG. 5.

The “first AP-ID” is an MAC address of the wireless LAN access point 2. The MAC address is information included in a radio signal transmitted from the wireless LAN access point 2.

The “second AP-ID” is information in which an ESS-ID of the wireless LAN access point 2 is combined with latitude/longitude information representing the position. The ESS-ID is information included in a radio signal transmitted from the wireless LAN access point 2, and the latitude/longitude information is information representing the current position of the wireless terminal 3 detected by the position detecting unit 24.

The “ranking” represents, for example, a degree of the user U's preference, and “ranking” of a high value is set to an AP-ID in a place that is high in the degree of the user U's preference.

4.1.2. Setting Information 32

FIG. 6 is a diagram illustrating an example of the setting information 32 stored in the storage unit 25. The setting information 32 includes information in which “registration information,” “list setting sensitivity,” and “entrance detection sensitivity” are associated with one another as illustrated in FIG. 6.

The “registration information” includes information such as “user ID,” “age,” “sex,” and “area.” The “user ID” is identification information specific to the user U of the wireless terminal 3 and is allocated by the information management device 4. The “age” and the “sex” are information representing an age and a sex of the user U. The “area” is information representing an area which the user U frequently visits.

The “list setting sensitivity” is setting information representing a reference used to generate the AP-ID list 31, and includes information such as “stay state,” “entrance frequency/number of times of entrance,” “coupon information use,” and “advertising information browse.” The “stay state” is a threshold value of the stay state in the AP communication area 7 determined by the stay state determination table 33, and the “entrance frequency/number of times of entrance” is a threshold value of the frequency of the entrance to the AP communication area 7 or a threshold value of the number of times of the entrance to the AP communication area 7.

The “coupon information use” is a flag representing whether or not the AP-ID corresponding to the AP communication area 7 is added to the AP-ID list 31 when the coupon information is used in the AP communication area 7. When the flag is “1,” the AP-ID is added to the AP-ID list 31 when the coupon information is used in the AP communication area 7, whereas when the flag is “0,” the AP-ID is not added to the AP-ID list 31.

The “advertising information browse” is a flag representing whether or not the AP-ID is added to the AP-ID list 31 when access to the advertising information corresponding to the installation place of the wireless LAN access point 2 is made. When the flag is “1,” the AP-ID is added to the AP-ID list 31, whereas when the flag is “0,” the AP-ID is not added to the AP-ID list 31.

The “entrance detection sensitivity” is information used to determine whether or not the wireless terminal 3 has entered the AP communication area 7, and includes information such as “stay period of time” and “radio field strength.” The “stay period of time” is a stay period of time of the wireless terminal 3 in the AP communication area 7. The “radio field strength” is radio field strength when the radio signal of the wireless LAN access point 2 is received by the wireless terminal 3.

4.1.3. Stay State Determination Table 33

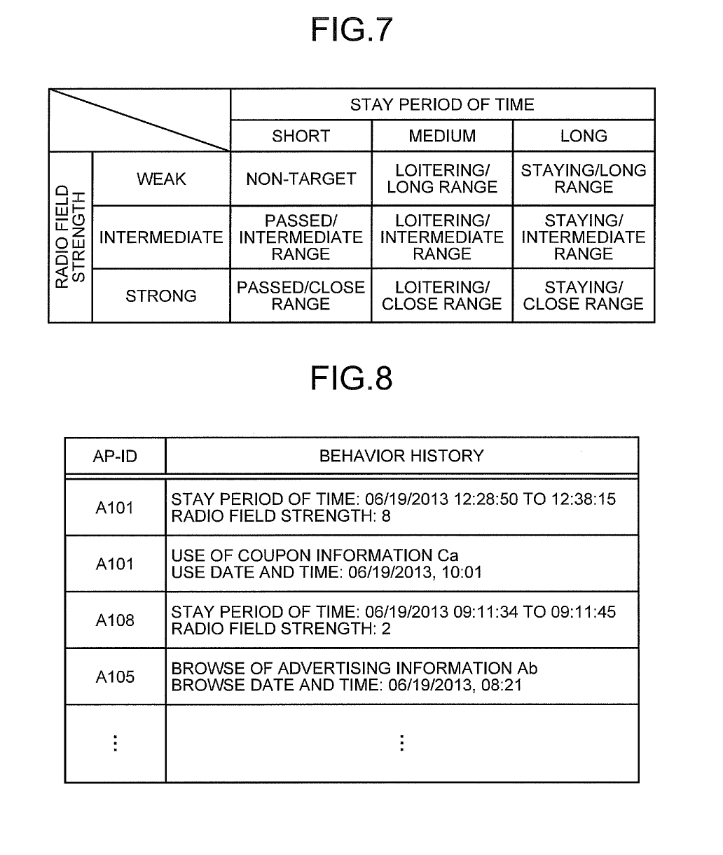

FIG. 7 is a diagram illustrating an example of the stay state determination table 33. The stay state determination table 33 is a table in which a type of a stay state, the length of a stay period of time, and the strength of radio field strength are associated with one another.

In the example of the stay state determination table 33 illustrated in FIG. 7, examples of the type of the stay state include “passed/intermediate range,” “passed/close range,” “loitering/long range,” “loitering/intermediate range,” “loitering/close range,” “staying/long range,” “staying/intermediate range,” and “staying/close range.” The types of the stay state illustrated in FIG. 7 are examples, and the stay state determination table 33 may be set according to any other classification.

In the stay state determination table 33, “short” represents a case in which the stay period of time is a first period of time threshold value or more and less than a second period of time threshold value, “medium” represents a case in which the stay period of time is the second period of time threshold value or more and less than a third period of time threshold value, and “long” represents a case in which the stay period of time is the third period of time threshold value or more.

Further, in the stay state determination table 33, “weak” represents a case in which the radio field strength is a first strength threshold value or more and less than a second strength threshold value, “intermediate” represents a case in which the radio field strength is the second strength threshold value or more and less than a third strength threshold value, and “strong” represents a case in which the radio field strength is the third strength threshold value or more. Here, each of the “stay period of time” and the “radio field strength” are classified into three states but may be classified into two states or four or more states.

4.1.4. Behavior History Information 34

FIG. 8 is a diagram illustrating an example of the behavior history information 34 stored in the storage unit 25. The behavior history information 34 is information in which “AP-ID” and “behavior history” are associated with each other as illustrated in FIG. 8. The “AP-ID” is the “first AP-ID” but may be the “second AP-ID.”

The “behavior history” is information representing behavior content of the user U of the wireless terminal 3. For example, the behavior history of the behavior history information 34 illustrated in FIG. 8 includes information of a stay date and time and radio field strength in the AP communication area 7 which the wireless terminal 3 has entered.

The stay date and time and the radio field strength are information detected by an entrance detecting unit 42 and set to the behavior history information 34 by the entrance detecting unit 42. The radio field strength is radio field strength of the radio signal received from the wireless LAN access point 2 received by the wireless LAN communication unit 20.

The behavior history of the behavior history information 34 illustrated in FIG. 8 further includes information representing a use of coupon information in the AP communication area 7 of the wireless LAN access point 2. The information representing a use of coupon information includes information of content and a use date and time of coupon information.

The behavior history of the behavior history information 34 illustrated in FIG. 8 further includes information representing a browse of advertising information corresponding to the installation place of the wireless LAN access point 2. The information representing a browse of advertising information includes information of content and a browse date and time of advertising information.

4.1.5. Provision Information 35

The provision information 35 is information which the control unit 26 acquires from, for example, the information management device 4 or the site server 8. For example, the provision information 35 is access information for coupon information or advertising information provided from the information management device 4. The access information is information used to access advertising information such as a Uniform Resource Locator (URL) of a device (for example, the information management device 4) providing advertising information.

4.2. Control Unit 26

The control unit 26 is implemented by an IC such as an ASIC or an FPGA. Further, the control unit 26 implements or performs a function or an operation of information processing which will be described later by executing a program stored in the storage unit 25 through a CPU, an MPU, or the like using an internal RAM (not illustrated) as a work area.

The control unit 26 executes the information notification card application whose program data is stored in the storage unit 25 and functions as the list generating unit 41, the entrance detecting unit 42, an information transmitting unit 43, an information receiving unit 44, and a display control unit 45. The configuration of the control unit 26 is not limited to the above-described configuration, and the control unit 26 may have any other configuration as long as information processing which will be described later is performed.

4.2.1. List Generating Unit 41

The list generating unit 41 generates and updates the AP-ID list 31 according to the behavior history of the user U of the wireless terminal 3. The AP-ID included in the AP-ID list 31 is an AP-ID of the wireless LAN access point 2 installed in a place corresponding to the user U's behavior. Examples of the place corresponding to the user U's behavior include a place often visited by the user U, a place preferred by the user U determined based on the user U's behavior (for example, a use of coupon information and a browse of advertising information), and a place to be recommended to the user U determined based on the user U's behavior.

The list generating unit 41 analyzes the user U's behavior based on the behavior history information 34 stored in the storage unit 25, determines a store which the user U often visits or prefers, and generates and updates the AP-ID list 31 based on the determination result.

Specifically, the list generating unit 41 determines a use result of coupon information by the user, an access result to advertising information, an entrance state to the AP communication area 7, and the like based on the behavior history information 34, determines the place corresponding to the user U's behavior such as a place often visited by the user U, a place preferred by the user U, and a place to be recommended to the user U, and generates and updates the AP-ID list 31.

For example, the list generating unit 41 adds the AP-ID of the wireless LAN access point 2 of the AP communication area 7 in which the user U has used the coupon information to the AP-ID list 31. Further, the list generating unit 41 may delete the AP-ID of the wireless LAN access point 2 of the AP communication area 7 in which the user U has not used the coupon information from the AP-ID list 31.

Further, for example, the list generating unit 41 adds the AP-ID of the wireless LAN access point 2 corresponding to the advertising information which has been browsed by the user U to the AP-ID list 31. Further, the list generating unit 41 may delete the AP-ID of the wireless LAN access point 2 corresponding to the advertising information which has not been browsed by the user U from the AP-ID list 31.

Further, for example, the list generating unit 41 adds the AP-ID of the wireless LAN access point 2 in which the entrance frequency, the number of times of entrance, or the entrance state of the wireless terminal 3 to the AP communication area 7 satisfies a condition set to the setting information 32 to the AP-ID list 31.

Specifically, the list generating unit 41 adds the AP-ID of the wireless LAN access point 2 in which the entrance frequency of the wireless terminal 3 to the AP communication area 7 is a threshold value or more to the AP-ID list 31. Further, the list generating unit 41 adds the AP-ID of the wireless LAN access point 2 in which the number of times of entrance of the wireless terminal 3 to the AP communication area 7 is a threshold value or more to the AP-ID list 31.

Further, the list generating unit 41 extracts the stay period of time and the radio field strength of the wireless terminal 3 in the AP communication area 7 from the behavior history information 34, and determines the type of entrance state of the wireless terminal 3 to the AP communication area 7 based on the stay state determination table 33 stored in the storage unit 25.

For example, “staying/close range” and “staying/intermediate range” are set as “stay state” of the setting information 32, and “3 times” is set as “number of times of entrance” of the setting information 32. In this case, the list generating unit 41 adds the AP-ID of the AP communication area 7 in which the state of “staying/close range” or “staying/intermediate range” is detected three times or more to the AP-ID list 31.

Further, “loitering/long range,” “loitering/intermediate range,” and “loitering/close range” are assumed to be set as “stay state” of the setting information 32, and “twice/week” is assumed to be set as “entrance frequency” of the setting information 32. In this case, the list generating unit 41 adds the AP-ID of the AP communication area 7 in which the state of “loitering/long range,” “loitering/intermediate range,” or “loitering/close range” is detected “twice/week” or more to the AP-ID list 31.

Further, the list generating unit 41 may add only an AP-ID present in an area set to “area” to the AP-ID list 31 when “area” of “registration information” is set to the setting information 32. The storage unit 25 stores the AP position information in which latitude/longitude information when the radio signal of the wireless LAN access point 2 is received is associated with an AP-ID, and the list generating unit 41 determines an area based on the AP position information stored in the storage unit 25.

4.2.2. Entrance Detecting Unit 42

The entrance detecting unit 42 detects the entrance to the AP communication area 7 of the wireless LAN access point 2 having the AP-ID included in the AP-ID list 31.

For example, when the MAC address included in the radio signal transmitted from the wireless LAN access point 2 is included in the AP-ID list 31 as the AP-ID, the entrance detecting unit 42 detects that the entrance to the AP communication area 7 corresponding to the AP-ID list 31 has been performed.

Further, when the wireless LAN communication unit 20 does not operate, the entrance detecting unit 42 acquires information of the moving longitude from the position detecting unit 24, and detects the entrance to the AP communication area 7 corresponding to the AP-ID list 31 when the second AP-ID including latitude/longitude information matching or approximate to the moving longitude is included.

For example, the AP-ID list 31 is assumed to be in the state illustrated in FIG. 5. In this case, when the latitude/longitude information detected by the position detecting unit 24 is “latitude/longitude A,” the entrance detecting unit 42 detects that the wireless terminal 3 has entered the AP communication area 7 corresponding to the AP-ID “A101” included in the AP-ID list 31.

Further, when the condition of “entrance detection sensitivity” included in the setting information 32 is satisfied, the entrance detecting unit 42 detects the entrance to the AP communication area 7. Specifically, when the radio field strength of the radio signal transmitted from the wireless LAN access point 2 is “radio field strength” of “entrance detection sensitivity” included in the setting information 32 or more and a reception duration of the radio signal transmitted from the wireless LAN access point 2 is “stay period of time” of “entrance detection sensitivity” included in the setting information 32 or more, the fact that the entrance to the AP communication area 7 has been performed is detected.

As described above, when the entrance to the AP communication area 7 of the wireless LAN access point 2 whose AP-ID is included in the AP-ID list 31 is made and the condition of “entrance detection sensitivity” is satisfied, the entrance detecting unit 42 determines that the entrance to the AP communication area 7 of the wireless LAN access point 2 having the AP-ID included in the AP-ID list 31 has been performed.

Then, when the entrance to the AP communication area 7 of the wireless LAN access point 2 having the AP-ID included in the AP-ID list 31 is detected, the entrance detecting unit 42 outputs the entrance information to the information transmitting unit 43. For example, the entrance information is information including the AP-ID (for example, the first AP-ID) of the wireless LAN access point 2 having the AP communication area 7 which the wireless terminal 3 has entered and the user ID of the user U of the wireless terminal 3. Further, the entrance detecting unit 42 may not include the user ID in the entrance information.

Further, when the entrance to the AP communication area 7 of the wireless LAN access point 2 is detected, regardless of the AP-ID list 31, the entrance detecting unit 42 adds the detection result to the behavior history information 34 as the behavior history in association with the AP-ID.

For example, a date and time at which the entrance to the AP communication area 7 of the wireless LAN access point 2 of the AP-ID “A101” is made is assumed to be from Jun. 19, 2013 12:28:50 to 12:38:15, and the radio field strength of the radio signal of the wireless LAN access point 2 received through the wireless LAN communication unit 20 is assumed to be “8.”

In this case, the entrance detecting unit 42 adds information of “stay period of time: Jun. 19, 2013 12:28:50 to 12:38:15” and “radio field strength: 8” to the behavior history information 34 as the behavior history of the AP-ID “A101” as illustrated in FIG. 8. Further, here, for the sake of convenience of description, the radio field strength is in a range of 0 to 10 as a relative strength, but dBm may be used as a unit.

Further, when the radio signal of the wireless LAN access point 2 is received, the entrance detecting unit 42 acquires the latitude/longitude information from the position detecting unit 24, and causes the latitude/longitude information to be stored in the storage unit 25 as the AP position information in association with the AP-ID of the wireless LAN access point 2.

4.2.3. Information Transmitting Unit 43

When the entrance to the AP communication area 7 is detected through the entrance detecting unit 42, the information transmitting unit 43 transmits the entrance information acquired from the entrance detecting unit 42 to the information management device 4. The entrance information includes the AP-ID of the wireless LAN access point 2 which the wireless terminal 3 has entered as described above.

Further, the information transmitting unit 43 transmits a request corresponding to the user's operation on the operating unit 23. For example, when the user operates the operating unit 23 to perform an initial setting of the information notification application, the information transmitting unit 43 transmits a registration request including registration information to the information management device 4 through the wireless LAN communication unit 20 or the wireless WAN communication unit 21. For example, the registration information is “registration information” of the setting information 32.

Further, for example, when the user operates the operating unit 23 to select access information of advertising information, the information transmitting unit 43 transmits an advertising information transmission request for an access destination based on the access information to an access destination device (for example, the information management device 4 or the site server 8) through the wireless LAN communication unit 20 or the wireless WAN communication unit 21. For example, the access information is information included in the provision information 35.

4.2.4. Information Receiving Unit 44

The information receiving unit 44 receives advertising content transmitted from the information management device 4 in response to transmission of the entrance information by the information transmitting unit 43, and adds the received advertising content to the provision information 35 of the storage unit 25. Further, information transmitted from the information management device 4 in response to the entrance information further includes news, peripheral information, and the like in addition to advertising content.

Further, the information receiving unit 44 receives coupon information transmitted from the information management device 4 in response to transmission of the registration request by the information transmitting unit 43, and adds the received coupon information to the provision information 35 of the storage unit 25. Further, the information receiving unit 44 receives registration information transmitted from the information management device 4 in response to transmission of the registration request by the information transmitting unit 43, and adds the received registration information to the setting information 32 of the storage unit 25.

Further, the information receiving unit 44 receives advertising information transmitted from the information management device 4 in response to transmission of the advertising information transmission request by the information transmitting unit 43, and adds the received advertising information to the provision information 35 of the storage unit 25.

Further, when the advertising information is received according to the advertising information transmission request, the information receiving unit 44 adds a browse history of the advertising information to the behavior history information 34. The advertising information includes the AP-ID of the relevant wireless LAN access point 2, and the information receiving unit 44 adds the browse history of the advertising information to the behavior history information 34 in association with the AP-ID included in the advertising information. The behavior history information 34 illustrated in FIG. 8 includes information representing that advertising information Ab corresponding to the wireless LAN access point 2 of the AP-ID “A105” has been browsed.

Further, the browse history of the advertising information may be added to the behavior history information 34 by the information transmitting unit 43 when the information transmitting unit 43 transmits the advertising information transmission request for the access destination based on the access information.

4.2.5. Display Control Unit 45

The display control unit 45 causes the setting information 32 or the provision information 35 stored in the storage unit 25 to be displayed on the display unit 22. The setting information 32 includes, for example, layout information of an initial setting screen or an information display screen in addition to “registration information,” “list setting sensitivity,” and “entrance detection sensitivity.”

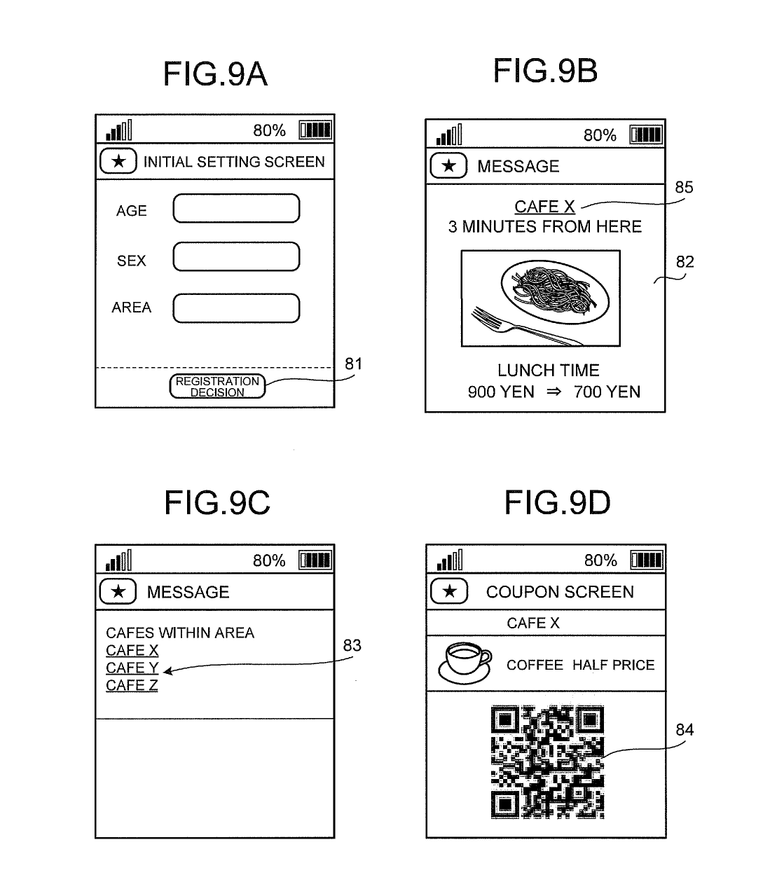

For example, when the initial setting is selected by the user U's operation on the operating unit 23 (hereinafter, referred to as a “user operation”), the display control unit 45 acquires the setting information 32 or the layout information from the storage unit 25, and causes the initial setting screen to be displayed on the display unit 22. FIG. 9A is a diagram illustrating an example of the initial setting screen. When the user U inputs “age,” “sex,” and “area” through the operating unit 23 and operates a “registration decision” button 81 on the initial setting screen, the display control unit 45 adds the input registration information to the setting information 32, and the information transmitting unit 43 transmits the registration request including the input registration information to the information management device 4.

Further, when advertising content is received and added to the provision information 35 by the information receiving unit 44, the advertising content added to the provision information 35 is extracted from the storage unit 25 and displayed on the display unit 22. FIG. 9B is a diagram illustrating an example of advertising content 82 displayed on the display unit 22.

As described above, when the wireless terminal 3 enters the wireless LAN access point 2 whose AP-ID is included in the AP-ID list 31 according to the user U's behavior history, the advertising content is provided to the user U. Further, in the example illustrated in FIG. 9B, access information 85 is added to the advertising content 82. The access information 85 includes a URL of a “cafe X.” When the access information 85 is selected by the user operation, access to the access destination is performed through the information transmitting unit 43, and the advertising information (for example, a web page of the cafe X) of the “cafe X” is acquired by the information receiving unit 44.

Further, for example, when access information is received and added to the provision information 35 by information receiving unit 44, the display control unit 45 extracts the access information added to the provision information 35 from the storage unit 25 and causes the access information to be displayed on the display unit 22. FIG. 9C is a diagram illustrating an example of access information 83 displayed on the display unit 22.

In the example illustrated in FIG. 9C, URLs of a “cafe X,” a “cafe Y,” and a “cafe Z” are included as the access information 83. When any one of the URLs of the access information 83 is selected by the user operation, access to the access destination is performed through the information transmitting unit 43, and the advertising information corresponding to the access information 83 is acquired by the information receiving unit 44 as described above.

Further, for example, when coupon information of the provision information 35 is selected by the user operation, the display control unit 45 extracts the coupon information from the storage unit 25 and causes the coupon information to be displayed on the display unit 22. FIG. 9D is a diagram illustrating an example of coupon information 84 displayed on the display unit 22.

The coupon information illustrated in FIG. 9D is a two-dimensional bar code but may be a one-dimensional bar code or any other information. When the coupon information 84 is displayed on the display unit 22, the display control unit 45 determines that the coupon information has been used, and adds the coupon information as the use history of the coupon information 84 to the behavior history information 34.

The use history of the coupon information 84 includes content of the used coupon information 84. The display control unit 45 adds the AP-ID of the wireless LAN access point 2 currently detected by the entrance detecting unit 42 to the behavior history information 34 together with content of the used coupon information. The behavior history information 34 illustrated in FIG. 8 includes information representing that coupon information Ca has been used in the AP-ID “A101.”

Further, for example, when the initial setting is selected by the user operation, the display control unit 45 may cause an input window of information such as “registration information,” “list setting sensitivity,” or “entrance detection sensitivity” to be displayed on the display unit 22 as an initial setting screen. In this case, when the user U inputs “registration information,” “list setting sensitivity,” or “entrance detection sensitivity” through the operating unit 23 and operates the “registration decision” button 81, the display control unit 45 adds the input information to the setting information 32, and then, the information transmitting unit 43 transmits the registration request to the information management device 4.

Further, when a setting information change is selected by the user operation, the display control unit 45 causes input window of “list setting sensitivity” or “entrance detection sensitivity” to be displayed on the display unit 22 as a setting information change screen, and changes the setting information 32 based on the information input by the user operation.

5. Information Management Device 4

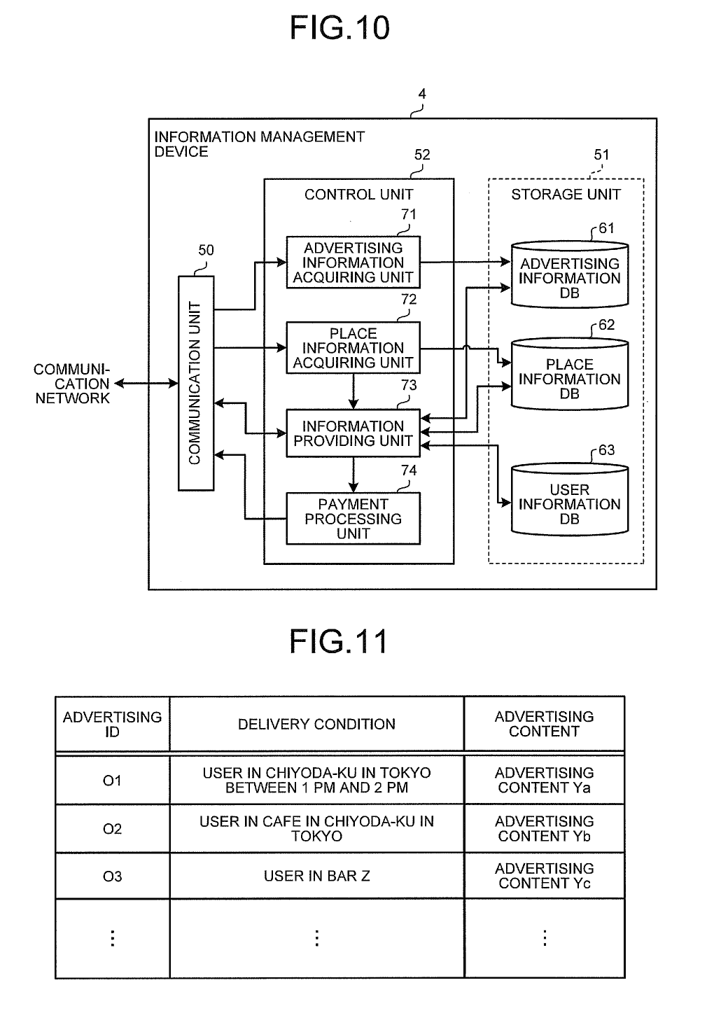

Next, a configuration of the information management device 4 will be concretely described. FIG. 10 is a diagram illustrating an exemplary configuration of the information management device 4. The information management device 4 includes a communication unit 50, a storage unit 51, and a control unit 52 as illustrated in FIG. 10. The storage unit 51 includes an advertising information DB 61, a place information DB 62, and a user information DB 63, and the control unit 52 includes an advertising information acquiring unit 71, a place information acquiring unit 72, an information providing unit 73, and a payment processing unit 74.

The communication unit 50 is an interface such as a network interface card (NIC). The control unit 52 can transmit or receive various kinds of information to or from the wireless LAN access point 2, the wireless terminal 3, and the site server 8 through the communication unit 50 and the communication network 6. For example, the advertising information DB 61, the place information DB 62, and the user information DB 63 are semiconductor memory devices such as hard disks, RAMs, or flash memories or storage devices such as optical discs.

For example, the control unit 52 is implemented by an IC such as an ASIC or an FPGA. Further, the control unit 52 functions as the advertising information acquiring unit 71, the place information acquiring unit 72, the information providing unit 73, and the payment processing unit 74 by executing a program stored in an internal storage device through an internal CPU or MPU using RAM as a work area.

Further, the configuration of the control unit 52 is not limited to the above-described configuration, and the control unit 52 may have any other configuration as long as information processing which will be described later is performed. Further, the information management device 4 includes a reading device (not illustrated), and the control unit 52 may read a program recorded in a recording medium in an internal storage device through the reading device and then implement the function of the control unit 52 by executing the program. Further, examples of the recording medium include an optical disc, a flexible disk, and a hard disk.

5.1. Advertising Information Acquiring Unit 71

The advertising information acquiring unit 71 receives a delivery request of advertising information from a device of an advertiser. The delivery request includes advertising information, and the advertising information includes a delivery condition such as a delivery destination and a delivery number and information of advertising content of a delivery target. When the delivery request of the advertising information is received, the advertising information acquiring unit 71 sets the received advertising information to the advertising information table of the advertising information DB 61.

FIG. 11 is a diagram illustrating an example of the advertising information table stored in the advertising information DB 61. The advertising information table includes information in which “advertising ID” is associated with “delivery condition” and “advertising content” as illustrated in FIG. 11.

The “advertising ID” is identification information allocated to each received delivery request, and is allocated by the advertising information acquiring unit 71. The “delivery condition” is a condition of a delivery destination of advertising content designated by the delivery request. The “advertising content” is advertising content of a delivery target, and for example, includes text advertising, still image advertising, moving image advertising, animation advertising, banner advertising, or the like.

For example, the “delivery condition” is a condition in which a region, a business type, a store, a time zone, or the like is set as a delivery destination. For example, in the example illustrated in FIG. 11, “user in Chiyoda-ku in Tokyo between 1 pm and 2 pm” is set as a delivery condition of an advertising ID “O1,” “user in cafe in Chiyoda-ku in Tokyo” is set as a delivery condition of an advertising ID “O2,” and “user in bar Z” is set as a delivery condition of an advertising ID “O3.”

Further, the advertising information DB 61 further stores the coupon information, the access information, and the like, and for example, the coupon information and the access information are stored in the advertising information DB 61 in association with a place of a relevant store. For example, the coupon information is associated with place information of a store in which the coupon information is used, and the access information is associated with place information corresponding to advertising information acquired by access.

5.2. Place Information Acquiring Unit 72

The place information acquiring unit 72 acquires the AP information of the wireless LAN access point 2 from the terminal device of the business operator, and sets the acquired AP information to the place information table of the place information DB 62. The AP information is information in which the AP-ID of the wireless LAN access point 2 is associated with the installation place information which is information related to the installation place of the wireless LAN access point 2. The installation place information includes a store name, a business type, a store position, and the like, but may include contents such as a degree of congestion, a customer base, business hours, a providing product, or a providing service of a store.

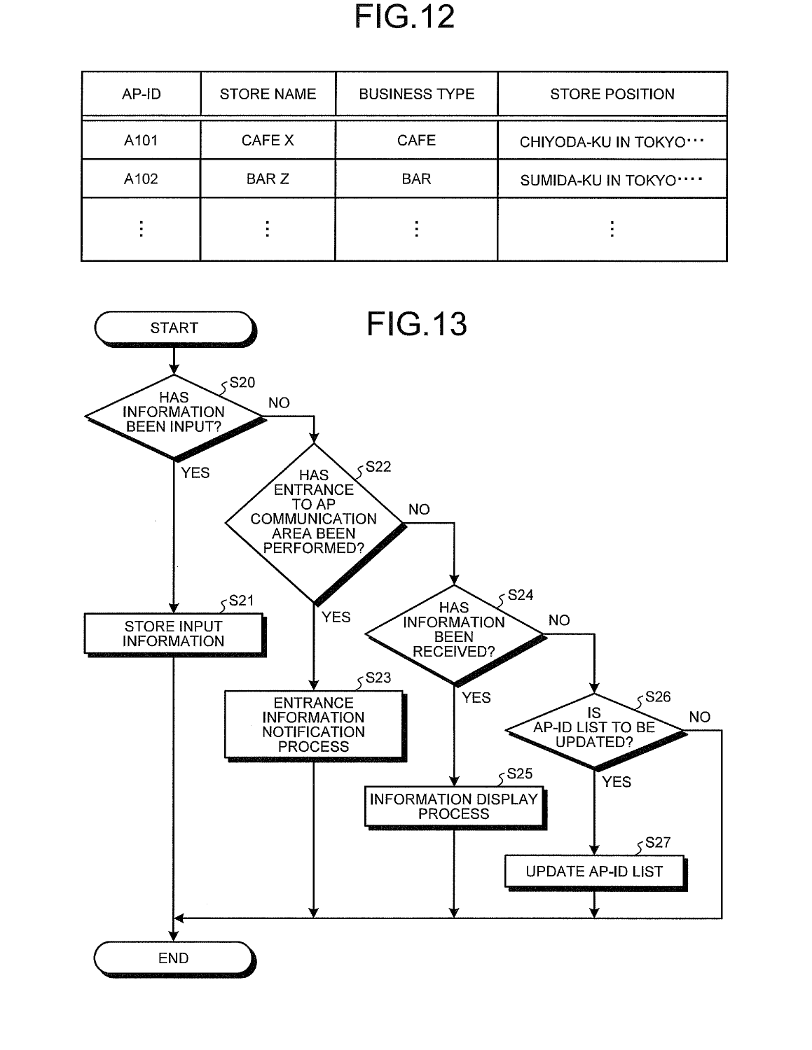

FIG. 12 is a diagram illustrating an example of a place information table stored in the place information DB 62. The place information table is information in which pieces of place information such as “AP-ID,” “store name,” “business type,” and “store position” are associated as illustrated in FIG. 12. The “store name,” “business type,” and “store position” represent a name, a business type, and an address of a store in which the wireless LAN access point 2 corresponding to the AP-ID is installed, respectively.

5.3. Information Providing Unit 73

The information providing unit 73 acquires information corresponding to information transmitted from the wireless terminal 3 from the advertising information DB 61, and transmits the acquired information to the wireless terminal 3.

For example, when the entrance information is acquired from the wireless terminal 3, the information providing unit 73 acquires place information corresponding to the AP-ID included in the entrance information from the place information table. The place information includes the “store name,” the “business type,” and the “store position,” but when contents of a degree of congestion, a customer base, business hours, a providing product, or a providing service of a store are present in the place information table, the information providing unit 73 may acquire such information.

Upon acquiring the place information, the information providing unit 73 extracts advertising content corresponding to the place information from the advertising information table. For example, when the advertising information table and the place information table are in the states illustrated in FIG. 11 and FIG. 12, respectively, and the AP-ID included in the entrance information is “A102,” the information providing unit 73 acquires advertising content Yc of an advertising ID “O3” in which place information “bar Z” is set as the delivery condition from the advertising information table.

Further, for example, when the AP-ID included in the entrance information is “A101,” the information providing unit 73 acquires advertising content Yb of an advertising ID “O2” in which a business type “cafe” and a store position “Chiyoda-ku in Tokyo” are set as the delivery condition from the advertising information table.

Further, since the delivery condition of an advertising ID “O1” is “Chiyoda-ku in Tokyo” and “between 1 pm and 2 pm,” the information providing unit 73 can acquire advertising content Ya of an advertising ID “O1” from the advertising information table when the AP-ID included in the entrance information is “A101” and a time zone is between 1 pm and 2 pm. The information providing unit 73 may decide which of the advertising content Ya and the advertising content Yb is acquired, for example, based on a delivery unit price or a residual delivery number of advertising content.

Further, when the registration request is received from the wireless terminal 3, the information providing unit 73 causes the registration information included in the registration request to be stored in the user information DB 63. The registration information includes information of an “area” which the user U of the wireless terminal 3 often goes to, and the information providing unit 73 acquires coupon information associated with the place information included in the “area” from the advertising information DB 61, and transmits the coupon information to the wireless terminal 3 that has made the registration request.

For example, coupon information of “cafe X in Chiyoda-ku in Tokyo” or “restaurant Y in Chiyoda-ku in Tokyo” is assumed to be stored in the advertising information DB 61. In this case, when the “area” of the registration information transmitted from the wireless terminal 3 is “Chiyoda-ku in Tokyo,” the information providing unit 73 extracts the coupon information of “cafe X” or “restaurant Y” from the advertising information DB 61, and transmits the extracted coupon information to the wireless terminal 3 that has made the registration request.

Further, when coupon information or advertising content is transmitted, the information providing unit 73 may extract access information from the advertising information DB 61 and add the coupon information or the advertising content to the access information.

5.4. Payment Processing Unit 74

The payment processing unit 74 calculates a compensation amount for a business operator (hereinafter, referred to as an “AP business operator”) having the wireless LAN access point 2 based on a transmission history of advertising content corresponding to place information by the information providing unit 73, and performs a payment process.

The number of times of transmission of advertising content is stored in the place information DB 62 in association with an AP-ID, and the payment processing unit 74 calculates a compensation amount for the AP business operator based on the number of times of transmission of advertising content stored in the place information DB 62 for each AP business operator that has provided place information, and performs the payment process. Further, for example, the payment processing unit 74 performs the payment process by transmitting a payment request including compensation information to a payment server (not illustrated) connected to the communication network 6.

6. Processing Flow of Information Provision System 1

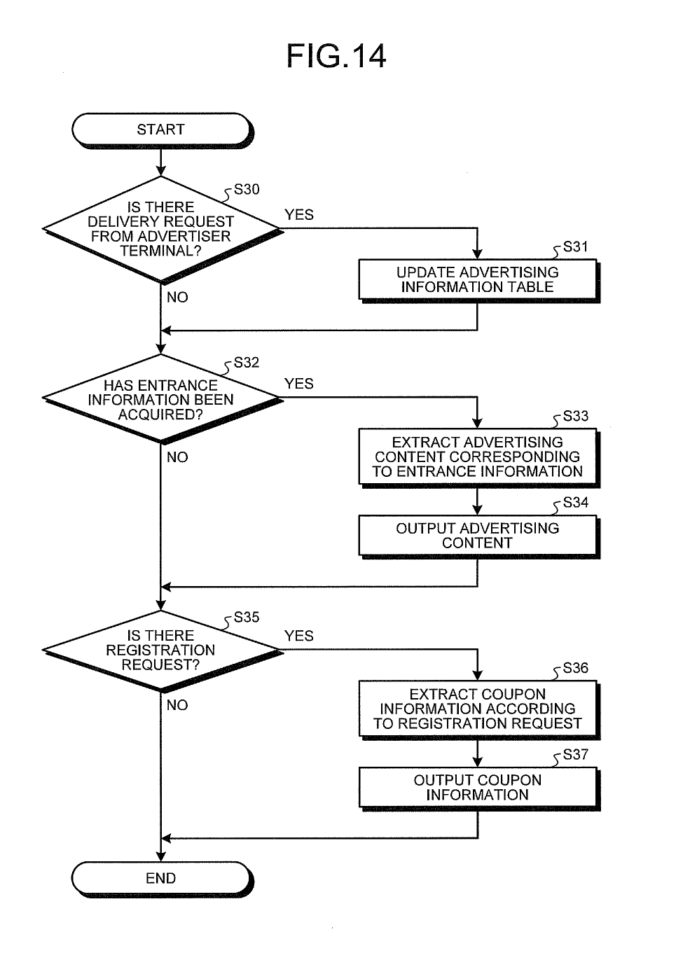

Next, a procedure of an information provision process performed by the information provision system 1 according to an embodiment will be described. FIGS. 13 and 14 are diagrams for describing the information provision processing flow performed by the information provision system 1. In the following, information processing of the wireless terminal 3 will be described with reference to FIG. 13, and information processing of the information management device 4 will be described with reference to FIG. 14.

6.1. Processing Flow of Wireless Terminal 3

First, information processing of the wireless terminal 3 according to an embodiment will be described. FIG. 13 is a flowchart illustrating exemplary information processing of the wireless terminal 3 according to an embodiment. This operation is a process repeatedly performed by the control unit 26 of the wireless terminal 3.

As illustrated in FIG. 13, the control unit 26 of the wireless terminal 3 determines whether or not information (for example, registration information, list setting sensitivity, entrance detection sensitivity, or the like) has been input by the user operation (step S20). When it is determined in this process that information has been input by the user operation (Yes in step S20), the input information is stored in the storage unit 25 (step S21). Further, when the input information includes registration information, the control unit 26 transmits the registration request to the information management device 4.

When it is determined that no information has been input by the user operation (No in step S20), the control unit 26 determines whether or not the wireless terminal 3 has entered the AP communication area 7 (step S22). When it is determined in this process that the wireless terminal 3 has entered the AP communication area 7 (Yes in step S22), the control unit 26 performs an entrance information notification process (step S23).

Specifically, when the entrance information notification process starts, the control unit 26 first determines whether or not the AP-ID of the wireless LAN access point 2 of the AP communication area 7 which the wireless terminal 3 has entered is included in the AP-ID list 31. When it is determined that the AP-ID corresponding to the entered AP communication area 7 is included in the AP-ID list 31, the control unit 26 transmits the entrance information including the AP-ID corresponding to the entered AP communication area 7 to the information management device 4.

When it is determined that the wireless terminal 3 has not entered the AP communication area 7 (No in step S22), the control unit 26 determines whether or not information has been received from the information management device 4 or the site server 8 (step S24). When it is determined that information has been received (yes in step S24), the control unit 26 causes the received information to be displayed on the display unit 22, and adds the received information to the provision information 35 of the storage unit 25 (step S25).

When it is determined that no information has been received (No in step S24), the control unit 26 determines whether or not the AP-ID list 31 is to be updated (step S26). In this process, the control unit 26 determines whether or not the AP-ID list 31 is to be updated based on the behavior history information 34. When it is determined that the AP-ID list 31 is to be updated (Yes in step S26), the control unit 26 updates the AP-ID list 31 (step S27).

After the process of steps S21, S23, S25, or S27 is performed, or when it is determined in step S26 that the AP-ID list 31 is not to be updated (No in step S26), the control unit 26 ends the process.

6.2. Processing Flow of Information Management Device 4

Next, information processing of the information management device 4 will be described. FIG. 14 is a flowchart illustrating information processing of the information management device 4 according to an embodiment. This operation is a process repeatedly performed by the control unit 52 of the information management device 4.

As illustrated in FIG. 14, the control unit 52 determines whether or not there is a delivery request of advertising information from the advertiser terminal 5 (step S30). When it is determined in this process that there is a delivery request of advertising information (Yes in step S30), the control unit 52 receives the delivery request of the advertising information, adds advertising information included in the delivery request to the advertising information table of the advertising information DB 61, and updates the advertising information table (step S31).

When it is determined in step S30 that there is no delivery request of advertising information (No in step S30) or after the process of step S31 is performed, the control unit 52 determines whether or not entrance information transmitted from the wireless terminal 3 has been acquired through the communication unit 50 (step S32). When it is determined that the entrance information has been acquired (Yes in step S32), the control unit 52 extracts advertising content corresponding to the acquired entrance information from the advertising information table of the advertising information DB 61 (step S33), and transmits the extracted advertising content to the wireless terminal 3 of the transmission source of the entrance information through the communication unit 50 (step S34).

When it is determined in step S32 that the entrance information has not been acquired (No in step S32) or after the process of step S34 is performed, the control unit 52 determines whether or not there is a registration request from the wireless terminal 3 (step S35). When it is determined in this process that there is a registration request from the wireless terminal 3 (Yes in step S35), the control unit 52 extracts coupon information corresponding to registration information from the advertising information DB 61 (step S36), and transmits the extracted coupon information to the wireless terminal 3 of the transmission source of the registration request through the communication unit 50 (step S37).

When it is determined in step S35 that there is no registration request from the wireless terminal 3 (No in step S35) or after the process of step S37 is performed, the control unit 52 ends the process.

7. Modified Example

The information management device 4 calculates a compensation amount for the AP business operator based on the number of times of transmission of advertising content and then performs the payment process, but the information management device 4 may calculates a compensation amount for the AP business operator based on the use history of the coupon information and then perform the payment process. In this case, a device (hereinafter, referred to as a “store device”) of a store or a business operator serving as a provision source of coupon information stores use history information of coupon information in the place information DB 62, and the payment processing unit 74 calculates a compensation amount for the AP business operator based on the use history of the coupon information transmitted from the store device and then performs the payment process. Further, the use history of the coupon information further includes a product or a service purchase history of the user U by the coupon information.

Further, the control unit 26 of the wireless terminal 3 detects the entrance to the AP communication area 7 based on the first AP-ID which is the MAC address of the wireless LAN access point 2, but may detect the entrance to the AP communication area 7 based on the second AP-ID including the ESS-ID and the latitude/longitude information.

For example, the AP-ID list 31 is assumed to be in the state illustrated in FIG. 5. In this case, when the ESS-ID included in the radio signal transmitted from the wireless LAN access point 2 is “Bies9eds” and the latitude/longitude information detected by the position detecting unit 24 is “latitude/longitude A,” the entrance detecting unit 42 detects that the wireless terminal 3 has entered the AP communication area 7 corresponding to the AP-ID list 31.

In this case, the control unit 26 of the wireless terminal 3 includes the second AP-ID in the entrance information, and transmits the resultant entrance information to the information management device 4. When the ESS-ID included in the entrance information acquired from the wireless terminal 3 and the second AP-ID corresponding to the latitude/longitude information are included in the place information table, the control unit 52 of the information management device 4 transmits advertising content corresponding to the installation place of the wireless LAN access point 2 which the wireless terminal 3 has entered.

Further, “area” has been described as the registration information transmitted from the wireless terminal 3 to the information management device 4 as an example, but instead “area,” for example, “genre” such as a business type, a product, or a service preferred by the user U may be set as the registration information. Further, both “area” and “genre” may be set as the registration information. Further, a plurality of “areas” or “genres” may be set.

Further, although information of “area” or “genre” is not included in the registration information transmitted from the wireless terminal 3 to the information management device 4, when the registration information is acquired through the wireless LAN access point 2, the information providing unit 73 may transmit the coupon information to the wireless terminal 3. For example, the information providing unit 73 extracts the coupon information of a genre corresponding to area or place information including place information of the wireless LAN access point 2 from the advertising information DB 61, and transmits the extracted coupon information to the wireless terminal 3.

Further, the above description has been made in connection with the example in which the control unit 52 of the information management device 4 extracts advertising content based on the place information, but advertising content may be extracted in view of the user information stored in the user information DB 63. For example, the user U's behavior history (for example, a web page reference history or a product purchase history) is assumed to be included in the user information stored in the user information DB 63. In this case, the control unit 52 of the information management device 4 extracts advertising content corresponding to the user information among advertising content according to the place information corresponding to the entrance information from the advertising information DB 61.

Further, the above description has been made in connection with the example in which a combination of a MAC address, an ESS-ID, and latitude/longitude information is used as an example of an AP-ID, but an AP-ID is not limited to the above-described identification information as long as identification information identifies the wireless LAN access point 2 and can be acquired by the wireless terminal 3.

Further, “coupon information use” included in the setting information 32 may be a threshold value of the number of times or the frequency that coupon information is used in the AP communication area 7 rather than a flag. Similarly, “advertising information browse” included in the setting information 32 may be a threshold value of the number of times or the frequency that accesses to advertising information corresponding to an installation place of the wireless LAN access point 2 is performed rather than a flag.

Further, the above description has been made in connection with the example in which the information management device 4 acquires AP information of the wireless LAN access point 2 from the terminal device of the business operator and sets the acquired AP information to the place information table of the place information DB 62, but the AP information may be set to the place information table based on information from the wireless terminal 3. For example, the installation place information may be included in the coupon information, and the control unit 26 of the wireless terminal 3 may transmit the coupon use information and the AP-ID included in the behavior history information 34 to the information management device 4 as the AP information.

For example, when the behavior history information 34 is in the state illustrated in FIG. 8, information including information of the coupon information Ca and the AP-ID “A101” is transmitted from the wireless terminal 3 to the information management device 4. The control unit 52 of the information management device 4 specifies installation place information of a store based on the coupon information Ca transmitted from the wireless terminal 3, and adds the installation place information of the specified store and the AP-ID transmitted from the wireless terminal 3 to the place information table in association with each other. Further, in this case, information in which the coupon information Ca is associated with the installation place information is stored in the storage unit 51 of the information management device 4, and the control unit 52 specifies installation place information of a store based on the coupon information Ca with reference to the information stored in the storage unit 51.

8. Effects

The information provision system 1 according to an embodiment includes a plurality of the wireless LAN access points 2, the wireless terminal 3 with a wireless LAN communication function, and the information management device 4. The wireless terminal 3 includes the list generating unit 41, the entrance detecting unit 42, the information transmitting unit 43, and the information receiving unit 44. The list generating unit 41 generates the AP-ID list 31 (an example of a list) of the AP-ID (an example of identification information) of the wireless LAN access point 2 according to the behavior history of the user U of the wireless terminal 3. The entrance detecting unit 42 detects the entrance to the AP communication area 7 of the wireless LAN access point 2 having the AP-ID included in the AP-ID list 31. When the entrance detecting unit 42 detects the entrance to the AP communication area 7, the information transmitting unit 43 transmits the AP-ID of the wireless LAN access point 2 having the entered AP communication area 7 to the information management device 4. The information receiving unit 44 receives advertising content (an example of information) transmitted from the information management device 4 in response to transmission of the AP-ID by the information transmitting unit 43. The information management device 4 includes the information providing unit 73, and the information providing unit 73 receives the entrance information including the AP-ID transmitted from the wireless terminal 3, and transmits advertising content corresponding to the AP-ID included in the received entrance information to the wireless terminal 3.

As described above, the wireless terminal 3 acquires information from the information management device 4 based on the AP-ID list 31 according to the user U's behavior history, and thus appropriate advertising content according to the user U's behavior can be provided to the user U. Further, the advertiser submits advertising information with a delivery condition for the user U who often goes to a certain place, and the advertiser can deliver advertising efficiently and effectively.

Further, the information management device 4 includes the place information DB 62 (an example of a place information storage unit) in which an AP-ID of the wireless LAN access point 2 is stored in association with place information related to an installation place of the wireless LAN access point 2. The information providing unit 73 acquires place information corresponding to the AP-ID of the wireless LAN access point 2 transmitted from the wireless terminal 3 from the place information DB 62, and transmits information corresponding to the place information to the wireless terminal 3.

Thus, appropriate advertising content according to the installation place of the wireless LAN access point 2 having the AP communication area 7 which the user U has entered can be provided to the user U of the wireless terminal 3.

Further, the information receiving unit 44 of the wireless terminal 3 acquires coupon information from the information management device 4. Then, the list generating unit 41 of the wireless terminal 3 adds an AP-ID of the wireless LAN access point 2 installed in a place in which the user U uses coupon information to the AP-ID list 31.

Thus, the AP-ID list 31 can be updated based on the fact that the user U uses coupon information, and the AP-ID list 31 according to the user U's behavior history can be easily generated or updated.

Further, the information transmitting unit 43 of the wireless terminal 3 transmits registration information (an example of input information) including an area input by the user U to the information management device 4. The information providing unit 73 of the information management device 4 receives registration information from the wireless terminal 3, and transmits coupon information corresponding to the registration information to the wireless terminal 3.

Thus, the user U's behavior range can be narrowed based on the user U's information, and by suppressing transmission of coupon information which is unlikely to be used to the wireless terminal 3, a reduction in an effect of coupon information caused by an increase in the number of coupon information provided by the user U can be avoided.

Further, the information receiving unit 44 of the wireless terminal 3 acquires access information used to access advertising information, and the list generating unit 41 of the wireless terminal 3 adds the AP-ID of the wireless LAN access point 2 corresponding to the advertising information to the AP-ID list 31 based on a result of accessing the advertising information.

As described above, the AP-ID list 31 is updated based on a result of accessing the advertising information, and thus the AP-ID list 31 according to the user U's behavior history can be easily generated or updated.

Further, the list generating unit 41 adds an AP-ID of the wireless LAN access point 2 in which the entrance state to the AP communication area 7 satisfies a predetermined condition to the AP-ID list 31.

Thus, the AP-ID list 31 can be updated according to a situation of the user U of the wireless terminal 3 in the AP communication area 7, and the AP-ID list 31 according to the user U's behavior history can be easily generated or updated.

Further, the list generating unit 41 determines the entrance state to the AP communication area 7 based on a stay period of time in the wireless LAN access point 2 and/or the radio field strength of a radio signal transmitted from the wireless LAN access point 2.

As described above, the entrance state to the AP communication area 7 is determined based on the stay period of time or the radio field strength, and thus the entrance of the user U of the wireless terminal 3 to the AP communication area 7 can be appropriately determined. For example, when the stay period of time is short or when the radio field strength is weak, the user U is unlikely to have nothing to do in the AP communication area 7, and in this case, entrance detection can be appropriately performed such that the entrance is assumed as not being detected even when the wireless terminal 3 is detected in the AP communication area 7.

Further, the information management device 4 includes the place information acquiring unit 72 and the payment processing unit 74. The place information acquiring unit 72 acquires place information from a device of the AP business operator having the wireless LAN access point 2, and stores the acquired place information in the place information DB 62. The payment processing unit 74 calculates a compensation amount for the AP business operator based on the number of times of transmission of advertising content (an example of information) according to the place information by the information providing unit 73, and then performs the payment process. When a delivery request of advertising information is received, the payment processing unit 74 can calculate a compensation amount for the AP business operator based on the number of times of transmission of advertising content designated by the delivery request, and the payment processing unit 74 can calculate a compensation amount for the AP business operator based on the number of times of actual transmission of advertising content.

Thus, the AP business operator having the wireless LAN access point 2 provides place information to the information management device 4 of the advertising distributor, and then gets a compensation amount for information provision from the advertising distributor. Thus, the AP business operator having the wireless LAN access point 2 is motivated to actively participate in an information providing service provided by the advertising distributor, and the scale of the information providing service can be easily increased.

Further, the information management device 4 includes the place information acquiring unit 72 and the payment processing unit 74. The place information acquiring unit 72 acquires place information from a device of the AP business operator having the wireless LAN access point 2 and stores the place information in the place information DB 62. The payment processing unit 74 calculates a compensation amount for the AP business operator based on a history of product or service purchase by advertising content according to the place information, and then performs the payment process.

Thus, the AP business operator having the wireless LAN access point 2 provides the place information to the information management device 4 of the advertising distributor, and then can get a compensation amount for information provision from the advertising distributor. Thus, the AP business operator having the wireless LAN access point 2 is motivated to actively participate in an information providing service provided by the advertising distributor, and the scale of the information providing service can be easily increased.

9. Others

The exemplary embodiment of the present disclosure have been described above with reference to the drawings, but the above embodiments are exemplary, and the present invention may be implemented in the forms in which various changes or improvements are made on the embodiments described in the detailed description based on knowledge of a person skilled in the art.

A configuration of the information management device 4 can be flexibly changed. For example, the information management device 4 may be implemented by a plurality of server computers, and depending on a function, an external platform or the like may be called and implementation may be made by an Application Programming Interface (API), a network computing, or the like.

According to an embodiment, it is possible to provide an information provision system, a wireless terminal, a program, and an information provision method, which are capable of providing information from an information management device to a wireless terminal that has entered a wireless communication area without transmitting detection information from a wireless LAN access point to the information management device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information provision system, comprising:
a wireless terminal with a wireless LAN communication function;
a plurality of wireless LAN access points; and
an information management device,
wherein the wireless terminal includes
a list generating unit configured to generate a list of identification information of the wireless LAN access points according to a behavior history of a user of the wireless terminal,
an entrance detecting unit configured to detect an entrance to a communication area of the wireless LAN access point having identification information included in the list,
an information transmitting unit configured to transmit the identification information of the wireless LAN access point having an entered communication area to the information management device when the entrance detecting unit detects the entrance to the communication area, and
an information receiving unit configured to receive information transmitted from the information management device in response to transmission of the identification information by the information transmitting unit, and
the information management device includes an information providing unit configured to receive the identification information transmitted from the wireless terminal and transmits information corresponding to the received identification information to the wireless terminal.

2. The information provision system according to claim 1,
wherein the information management device further includes a place information storage unit configured to store the identification information of the wireless LAN access point and place information related to an installation place of the wireless LAN access point in association with each other, and
the information providing unit of the information management device acquires place information corresponding to the identification information of the wireless LAN access point transmitted from the wireless terminal from the place information storage unit, and transmits the information corresponding to the place information to the wireless terminal.

3. The information provision system according to claim 1,
wherein the information receiving unit of the wireless terminal acquires coupon information from the information management device, and
the list generating unit of the wireless terminal adds the identification information of the wireless LAN access point installed in a place in which the user uses the coupon information to the list.

4. The information provision system according to claim 3,
wherein the information transmitting unit of the wireless terminal transmits input information of an area by the user to the information management device, and
the information providing unit of the information management device receives the input information from the wireless terminal, and transmits the coupon information corresponding to the input information to the wireless terminal.

5. The information provision system according to claim 1,
wherein the information receiving unit of the wireless terminal acquires access information used to access advertising information, and
the list generating unit of the wireless terminal adds the identification information of the wireless LAN access point corresponding to the advertising information to the list based on a result of accessing the advertising information.

6. The information provision system according to claim 1,
wherein the list generating unit adds the identification information of the wireless LAN access point in which an entrance state to the communication area satisfies a predetermined condition to the list.

7. The information provision system according to claim 6,
wherein the list generating unit determines the entrance state to the communication area based on a stay period of time in the wireless LAN access point and/or radio field strength of a radio signal received from the wireless LAN access point.

8. A wireless terminal, comprising:
a list generating unit configured to generate a list of identification information of wireless LAN access points according to a behavior history of a user;
an entrance detecting unit configured to detect an entrance to a communication area of the wireless LAN access point having identification information included in the list;
an information transmitting unit configured to transmit the identification information of the wireless LAN access point having an entered communication area to an information management device when the entrance detecting unit detects the entrance to the communication area; and
an information receiving unit configured to receive information transmitted from the information management device in response to transmission of the identification information by the information transmitting unit.

9. The wireless terminal according to claim 8,
wherein the information receiving unit acquires coupon information from the information management device, and
the list generating unit adds the identification information of the wireless LAN access point installed in a place in which the user uses the coupon information to the list.

10. The wireless terminal according to claim 8,
wherein the information receiving unit acquires access information used to access advertising information, and
the list generating unit adds the identification information of the wireless LAN access point corresponding to the advertising information to the list based on a result of accessing the advertising information.

11. The wireless terminal according to claim 8,
wherein the list generating unit adds the identification information of the wireless LAN access point in which an entrance state to the communication area satisfies a predetermined condition to the list.

12. The wireless terminal according to claim 11,
wherein the list generating unit determines the entrance state to the communication area based on a stay period of time in the wireless LAN access point and/or radio field strength of a radio signal received from the wireless LAN access point.

13. A non-transitory computer readable storage medium containing program instructions for providing information, wherein execution of the program instructions by one or more processors of a computer system causes the one or more processors to perform:
generating a list of identification information of wireless LAN access points according to a behavior history of a user;
detecting an entrance to a communication area of the wireless LAN access point having identification information included in the list;
transmitting the identification information of the wireless LAN access point having an entered communication area to an information management device; and
an information receiving unit configured to receive information transmitted from the information management device in response to transmission of the identification information by the transmitting.

14. An information providing method, comprising:
generating, by a wireless terminal, a list of identification information of wireless LAN access points according to a behavior history of a user of the wireless terminal;
detecting, by the wireless terminal, an entrance to a communication area of the wireless LAN access point having identification information included in the list;
transmitting, by the wireless terminal, the identification information of the wireless LAN access point having an entered communication area to a information management device when the entrance to the communication area is detected by the detecting of the entrance; and
receiving, by the information management device, the identification information transmitted from the wireless terminal and transmitting information corresponding to the received identification information to the wireless terminal; and
receiving, by the wireless terminal, information transmitted from the information management device in response to transmission of the identification information by the transmitting of the identification information.

15. The information providing method according to claim 14,
wherein the acquiring includes acquiring place information corresponding to the identification information of the wireless LAN access point transmitted from the wireless terminal from a place information storage and transmits the information corresponding to the place information to the wireless terminal.

16. The information providing method according to claim 14, further comprising:
acquiring, by the wireless terminal, coupon information from the information management device, and
adding, by the wireless terminal, the identification information of the wireless LAN access point installed in a place in which the user uses the coupon information to the list.

17. The information providing method according to claim 16, further comprising:
transmitting, by the wireless terminal, input information of an area by the user to the information management device, and
receiving, by the information management device, the input information from the wireless terminal, and
transmitting, by the information management device, the coupon information corresponding to the input information to the wireless terminal.

18. The information providing method according to claim 14, further comprising:
acquiring, by the wireless terminal, access information used to access advertising information, and
adding, by the wireless terminal, the identification information of the wireless LAN access point corresponding to the advertising information to the list based on a result of accessing the advertising information.

19. The information providing method according to claim 14, further comprising:
adding, by the wireless terminal, the identification information of the wireless LAN access point in which an entrance state to the communication area satisfies a predetermined condition to the list.

20. The information providing method according to claim 19, further comprising:
determining the entrance state to the communication area based on a stay period of time in the wireless LAN access point and/or radio field strength of a radio signal received from the wireless LAN access point.
